(19) United States
(12) Patent Application Publication
(10) Pub. No.: US 2008/0126776 A1
(43) Pub. Date: May 29, 2008

(54) Electronic apparatus

(75) Inventor: Katsumi Takayama, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/984,952

(22) Filed: Nov. 26, 2007

(30) Foreign Application Priority Data
Nov. 27, 2006 (JP) 2006-319182

(51) Int. Cl. G06F 15/177

(52) U.S. Cl. 713/1

(57) ABSTRACT

The electronic apparatus includes: a central processing unit; a non-volatile memory which is non-rewritable and stores a boot program; a first volatile memory which enables fast reading and writing of data and does not require initialization; a second volatile memory which enables fast reading and writing of data and requires initialization; and a first flash memory which is serial and stores at least a parameter necessary for the central processing unit to perform initialization of a system in an area designated with a first physical address, and a main program to be executed by the central processing unit in an area designated with one of a second physical address and the parameter. When the electronic apparatus is powered on, the central processing unit executes the boot program stored in the non-volatile memory so that the central processing unit performs transfer of the parameter from the first flash memory to the first volatile memory by reading the parameter from the first flash memory and temporarily storing the read parameter into the first volatile memory, and then performs the initialization of the system according to the parameter stored in the first volatile memory, thereafter performs transfer of the main program stored in the first flash memory to the second volatile memory, and then starts the main program on the second volatile memory.

### BACKGROUND OF THE INVENTION

1. Field of the Invention

The present invention relates to an electronic apparatus, more specifically to a technology for performing system boot of the electronic apparatus of which program (firmware) is stored in a serial flash memory.

2. Description of the Related Art

Serial flash memory (e.g., NAND flash memory) has such advantages that it is less expensive and allows greater storage densities than parallel flash memory (e.g., NOR flash memory). NAND flash memory, however, has such disadvantages that data stored in NAND flash memory cannot be accessed by a byte at a time unlike NOR flash memory but accessed on a block-wise basis; and hence, when executing a program stored in NAND flash memory, the program cannot be directly executed without being located into a main memory.

Moreover, NAND flash memory is permitted to include defective blocks, so that when NAND flash memory is accessed, data are written and read as managing locations of the defective blocks.

Japanese Patent Application Publication No. 2005-190201 discloses a system in which a main program and a boot program are stored in a NAND flash memory, and a boot ROM (e.g., NOR memory) is not used. The system is provided with a specific transferring apparatus which, when the system is powered on, reads the boot program with an error detection code stored in the NAND flash memory, executes an error detection and correction process, and then transfers the read program to an SRAM. When the transfer is normally completed, a central processing unit (CPU) is caused to be available, and the CPU performs the system boot by executing the boot program having been transferred to the SRAM. The system needs a dedicated sequencer (transferring apparatus) that controls the NAND flash memory without relying on the CPU, and the dedicated sequencer cannot be shared with an interface for an external memory card, so that it becomes high-cost.

Japanese Patent Application Publication No. 2002-278781 discloses a storage apparatus including a boot ROM in which an initial load program is stored, a NAND flash memory having a firmware area and a user area, and a RAM having an instruction storage area and a data storage area. The CPU reads the initial load program from the boot ROM and executes it, so as to specify program configuration data from the NAND flash memory and store them into the instruction storage area of the RAM. This system cannot be flexible because the device for initializing the RAM is fixed.

Japanese Patent Application Publication No. 2004-220557 discloses a serial flash access apparatus which causes a boot code, etc. stored in a NAND flash memory to be accessible by a byte at a time. The serial flash access apparatus includes: a cache module, which accesses a memory address of the NAND flash memory that is designated by the CPU, and reads and writes data required from the CPU; a serial flash controller, which reads the boot code written in the NAND flash memory to store in a buffer, and is provided with a boot loader performing the system boot when the boot code is required from the CPU; and a flash interface unit, which controls data transmission between the cache module and the serial flash controller, and the NAND flash memory.

Japanese Patent Application Publication No. 2004-319048 discloses a NAND flash memory having a ROM area for storing a boot program, an error correction circuit for correcting errors of data stored in the ROM area, and a function for booting the system.

The NAND flash memory disclosed in Japanese Patent Application Publication Nos. 2004-220557 and 2004-319048 has the function for allowing the CPU to directly access the NAND flash memory, so that the NAND flash memory itself becomes high-cost as compared with the standard NAND flash memory.

Japanese Patent Application Publication No. 2005-010942 discloses a method and an apparatus which can boot up without an additional boot ROM as using a NAND flash memory.

Japanese Patent Application Publication No. 2005-107938 discloses a computer boot system which sets a boot program code as an initial value in a control register of a peripheral device, and when being powered on, reads the boot program code from the control register, executes the boot program, and transfers a main program stored in a NAND flash memory to a DRAM. This system requires the peripheral device provided with the control register that sets the boot program code as the initial value, besides the NAND flash memory.

Any usage of the above-described NAND flash memory controller is limited to the program storage and the access to one NAND flash memory, and it is not shared with an access device to an exchangeable NAND flash memory such as an external memory card. Hence, when the external memory card is used, as another controller is necessary, it becomes high-cost.

### SUMMARY OF THE INVENTION

The present invention has been contrived in view of the foregoing circumstances, and the object is to provide an electronic apparatus which can construct a low-cost and flexible system in the electronic apparatus storing the main program in the serial flash memory.

In order to attain the aforementioned object, the present invention is directed to an electronic apparatus, comprising: a central processing unit; a non-volatile memory which is non-rewritable and stores a boot program; a first volatile memory which enables fast reading and writing of data and does not require initialization; a second volatile memory which enables fast reading and writing of data and requires initialization; and a first flash memory which is serial and stores at least a parameter necessary for the central processing unit to perform initialization of a system in an area designated with a first physical address, and a main program to be executed by the central processing unit in an area designated with one of a second physical address and the parameter, wherein when the electronic apparatus is powered on, the central processing unit executes the boot program stored in the non-volatile memory so that the central processing unit performs transfer of the parameter from the first flash memory to the first volatile memory by reading the parameter from the first flash memory and temporarily storing the read parameter into the first volatile memory, and then performs the initialization of the system according to the parameter stored in the first volatile memory, thereafter performs transfer of the main program stored in the first flash memory to the second volatile memory, and then starts the main program on the second volatile memory.

According to this first aspect of the present invention, the boot program (ROM code) is stored in the non-volatile and non-rewritable memory (e.g. lower-capacity ROM), the parameter necessary to initialize the system and the main program are stored in the first flash memory such as NAND flash memory. The central processing unit (CPU) executes the ROM code so that the CPU reads the parameter from the area designated by the first physical address of the first flash memory, and locates the read parameter to the first volatile memory (e.g., SRAM), and the CPU initialize and sets the system with reference to the parameter stored in the SRAM. Meanwhile, the SRAM does not require initialization, so that the CPU can access the SRAM.

When the initialization of the system is completed, the CPU reads the main program stored in an area of the first flash memory designated by the specific second physical address or the parameter, stores the read main program in the second volatile memory (e.g., DRAM), and starts the main program there.

Hence, the system can be realized at a lower cost than a system that includes NAND flash memory and expensive NOR flash memory storing the main program. Moreover, a flexible system can be structured with the parameter stored in the first flash memory without changing the ROM code.

According to a second aspect of the present invention, the electronic apparatus in the first aspect further includes: a memory controller which includes an error detection and correction device, wherein: the central processing unit performs the transfer of the parameter and the main program through the memory controller; and the memory controller performs error detection and correction for the parameter and the main program transferred through the memory controller. Thereby, it is possible to increase the reliability of the parameter and the main program stored in the NAND flash memory of which reliability is lower than that of the NOR flash memory.

According to the third aspect of the present invention, in the second aspect, the central processing unit, the non-volatile memory, the first volatile memory, and the memory controller are configured in one chip of large-scale integrated circuit.

According to the fourth aspect of the present invention, the electronic apparatus in the first aspect further includes: an interface which externally connects with a second flash memory and transmits and receives data with the second flash memory, the second flash memory being serial, wherein the first volatile memory which temporarily stores the parameter at the initialization serves as a data buffer when the second flash memory is used. Thereby, the system can be realized at a lower cost by sharing the first volatile memory (SRAM) as the data buffer that is used when data is transferred as using the second flash memory.

According to the fifth aspect of the present invention, in the first aspect, the parameter stored in the first flash memory includes a parameter for initializing the second volatile memory. Thereby, the system can be configured with any of the second volatile memories (DRAMs) of which sizes and types are different without changing the ROM code.

According to the sixth aspect of the present invention, in the first aspect, the parameter stored in the first flash memory includes: a parameter for setting a clock frequency of the system by which the central processing unit performs the transfer of the main program from the first flash memory to the second volatile memory, and a parameter for setting a pulse width of a control signal by which the central processing unit accesses the first flash memory. Thereby, the initialization can be speeded up.

According to the seventh aspect of the present invention, in the first aspect, the parameter stored in the first flash memory includes a parameter indicating a size of the main program to be transferred from the first flash memory to the second volatile memory. Thereby, the size of the program can be changed without changing the ROM code.

According to the eighth aspect of the present invention, in the second aspect, the parameter stored in the first flash memory includes a parameter indicating an allowable number of times of retrying when the central processing unit performs the transfer of the main program; and if it is detected that an uncorrectable error has been induced when the central processing unit performs the transfer of the main program, the central processing unit retries the transfer of the main program within a limit of the allowable number of times of retrying.

According to the ninth aspect of the present invention, in the second aspect, the boot program stored in the non-volatile memory includes a parameter indicating an allowable number of times of retrying when the central processing unit performs the transfer of the parameter and the main program; and if it is detected that an uncorrectable error has been induced when the central processing unit performs the transfer of one of the parameter and the main program, the central processing unit retries the transfer of the one of the parameter and the main program within a limit of the allowable number of times of retrying.

According to each of the eighth and ninth aspects, a high reliability can be obtained.

According to the tenth aspect of the present invention, in the second aspect, if it is detected that an uncorrectable error has been induced when the central processing unit performs the transfer of the parameter and the main program, the central processing unit issues a control signal so as to turn off power of a power source circuit. Thereby, the electronic apparatus can be protected when it is not normally started.

According to the eleventh aspect of the present invention, in the second aspect, the first flash memory has a user area in which user data is stored; the first flash memory stores a first error correction code in an area in which the parameter and the main program are stored; and the first flash memory stores a second error correction code in the user area, the second error correction code being capable of error correction weaker than the first error correction code.

According to the present invention, the parameters necessary to initialize the system and the main program are stored in the serial first flash memory, the CPU executes the boot program stored in the non-volatile and non-rewritable memory (e.g. a lower-capacity ROM) to read and transfer the parameter from the first flash memory to the first volatile memory (SRAM), and initializes and sets the system with reference to the parameter, so that a flexible system can be structured without changing the ROM code. After completing the initialization of the system, the CPU reads the main program from the first flash memory to locate the main program to the second volatile memory (DRAM), and starts the main program in the second volatile memory (DRAM), so that the system can be realized at a lower cost as compared with an system that stores the main program in expensive NOR flash memory.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a main block diagram of an electronic apparatus according to an embodiment of the present invention;

FIG. 2 is a diagram illustrating a setting example of a memory map of the NAND flash memory;

FIG. 3 is a flowchart illustrating operations for starting the electronic apparatus according to a first embodiment of the present invention;

FIG. 4 is a flowchart illustrating operations for starting the electronic apparatus according to a second embodiment of the present invention;

FIG. 5 is a flowchart illustrating operations for starting the electronic apparatus according to a third embodiment of the present invention;

FIG. 6 is a flowchart illustrating operations for starting the electronic apparatus according to a fourth embodiment of the present invention;

FIG. 7 is a flowchart illustrating operations for starting the electronic apparatus according to a fifth embodiment of the present invention;

FIG. 8 is a flowchart illustrating operations for starting the electronic apparatus according to a sixth embodiment of the present invention;

FIG. 9 is a main block diagram illustrating an electronic apparatus according to another embodiment of the present invention;

FIG. 10 is a flowchart illustrating operations for starting the electronic apparatus according to a seventh embodiment of the present invention; and

FIG. 11 is a diagram illustrating a memory map of NAND flash memory in which data areas and redundant areas are defined.

### DETAILED DESCRIPTION OF THE PREFERRED EMBODIMENTS

### Configuration of the Electronic Apparatus

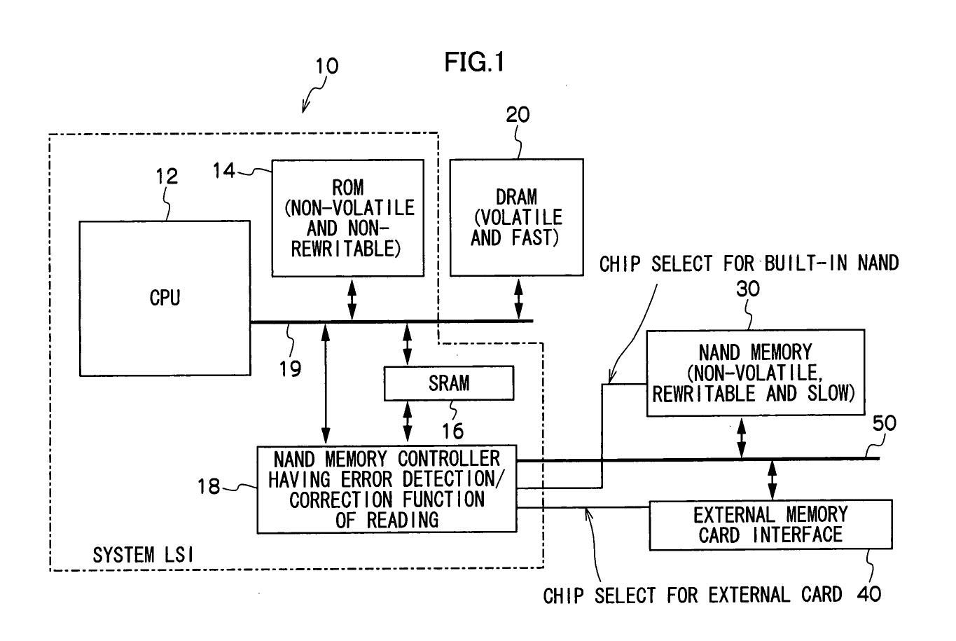

FIG. 1 is a main block diagram of an electronic apparatus according to an embodiment of the present invention.

The electronic apparatus (e.g., a digital camera) is controlled by a program (firmware) and includes a system LSI (large-scaled integrated circuit) 10, a volatile memory (e.g., DRAM) 20 that enables fast reading and writing of data and requires initialization, a serial flash memory (e.g., NAND flash memory) 30, and a memory card interface 40 to a memory card, which is an external NAND flash memory.

The system LSI 10 includes a central processing unit (CPU) 12, a nonvolatile and non-rewritable memory (ROM) 14, a volatile memory (e.g., SRAM) 16 that enables fast reading and writing of data and does not require initialization, a NAND memory controller 18, and a system bus 19 connecting these components each other. The system LSI 10 is configured in one chip, and has a composition in which the ROM 14 of a small capacity is added as compared with such a kind of conventional system LSI.

The ROM 14 stores a boot program (hereinafter, referred to as “ROM code”), and the CPU 12 executes the ROM code when booting as described later.

The DRAM 20 is connected to the system LSI 10 through the system bus 19. The built-in NAND flash memory 30 and the memory card interface 40 are connected to the NAND memory controller 18 in the system LSI 10 through a media bus 50.

The NAND memory controller 18 has an error detection and correction function as described later, applies a chip select signal to any one of the built-in NAND flash memory 30 and the external NAND flash memory connecting through the memory card interface 40, and reads and writes data with the NAND flash memory to which the chip select signal is applied.

### Configuration of the NAND Flash Memory 30

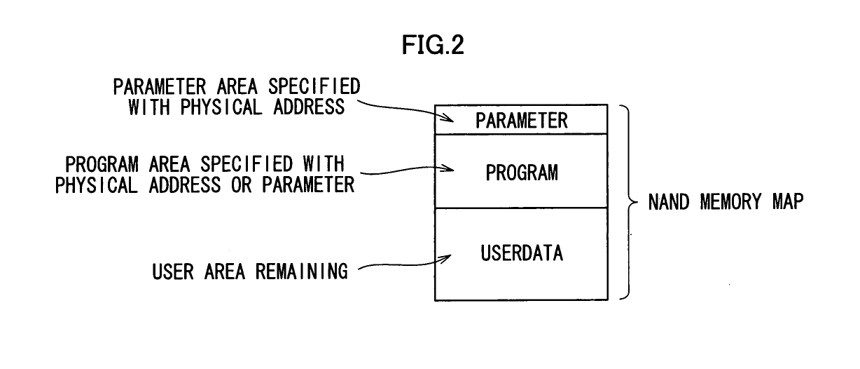

FIG. 2 is a diagram illustrating a setting example of a memory map of the NAND flash memory 30. The NAND flash memory 30 has many blocks, and each block is further divided to a plurality of pages (e.g., 512 bytes per page), and it can be read and programmed by a page basis.

As illustrated in FIG. 2, the NAND flash memory 30 stores parameters necessary for the CPU 12 to perform initialization of a system in an area designated with a specific physical address (in the present embodiment, a first page of a first block), and stores the main program in an area designated with the parameter or another specific physical address, and other area can be used as a user area.

Operations when starting the electronic apparatus according to embodiments of the present invention are described below.

### First Embodiment

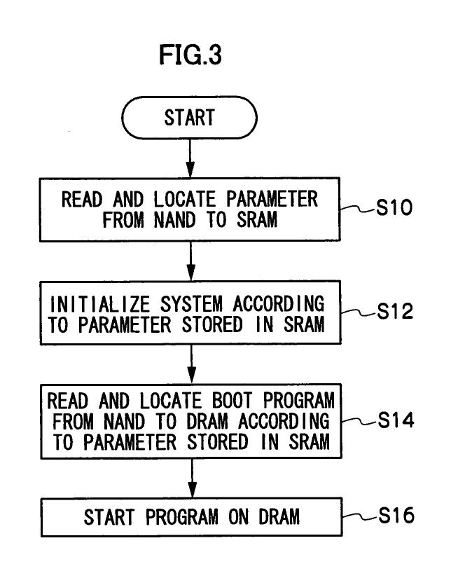

FIG. 3 is a flowchart illustrating operations for starting the electronic apparatus according to a first embodiment of the present invention.

When the electronic apparatus is powered on (or when the power-on reset is executed), the CPU 12 first executes the ROM code in the ROM 14 to perform the initialization of the system that is minimally necessary to control the NAND memory controller 18, then selects only the chip select signal for the NAND flash memory 30 by controlling the NAND memory controller 18, accesses the area designated with the specific physical address (the first page of the first block) of the NAND flash memory 30, reads parameters from the designated area, and locates the read parameters into the SRAM 16 (step S10).

The CPU 12 then performs the system initialization by using the parameters stored in the SRAM 16 (step S12). Since the SRAM 16 does not require initialization, the CPU 12 can immediately access the SRAM 16, and can initialize and set the system by referring to the parameters stored in the SRAM 16.

Next, the CPU 12 reads the main program from the area (where the main program is stored) of the NAND flash memory 30 designated with the parameters stored in the SRAM 16, and locates the read main program in the DRAM 20 (step S14). When the specific physical address is included in the ROM code which address indicates the area where the main program is stored, it is possible to read the main program according to the specific physical address in the ROM code.

Thereafter, the CPU 12 changes a program counter to the address of the area on the DRAM 20 to which the main program has been located, and starts the main program on the DRAM 20 (step S16).

After the system is started, the SRAM 16 serves as a data buffer when the NAND flash memory 30 or the memory card (not illustrated) connected to the memory card interface 40 is used. That is, the SRAM 16 is used as the data buffer for transferring data of the NAND flash memory 30 or the memory card, while the SRAM 16 is effectively utilized when booting in the present embodiment.

### Second Embodiment

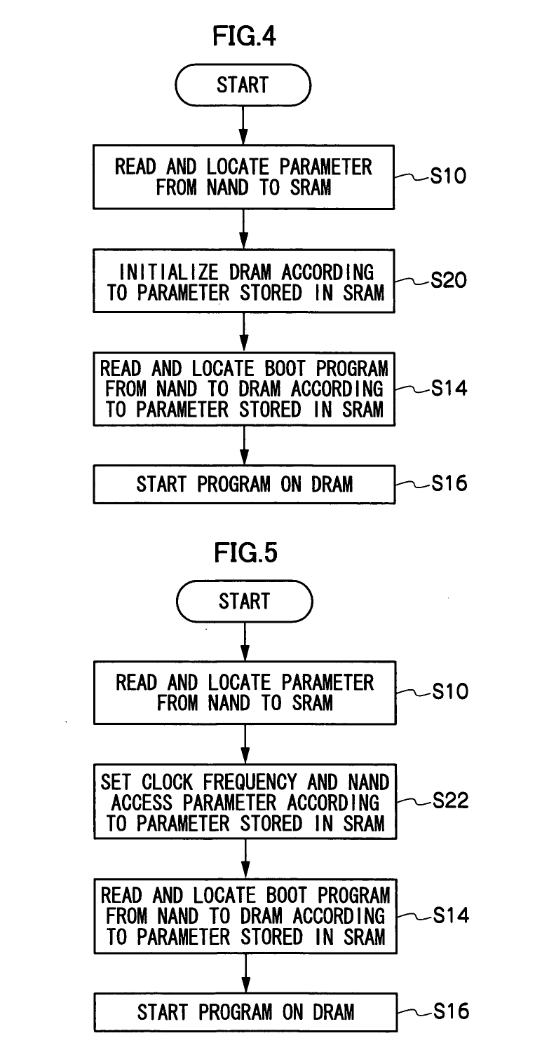

FIG. 4 is a flowchart illustrating operations for starting the electronic apparatus according to a second embodiment of the present invention. The steps described in the first embodiment with reference to FIG. 3 are denoted with the same reference numerals in FIG. 4, and the detailed description thereof is omitted.

In the second embodiment illustrated in FIG. 4, the processing of step S20 is executed instead of step S12 of the first embodiment.

The parameters stored in the NAND flash memory 30 include a parameter for initializing the DRAM 20.

At step S20 for initializing the system, the CPU 12 initializes the DRAM 20 by using the parameter for initializing the DRAM 20, which parameter is one of the parameters stored in the SRAM 16. Thereby, any of DRAMs of various capacities and types can be used.

### Third Embodiment

FIG. 5 is a flowchart illustrating operations for starting the electronic apparatus according to a third embodiment of the present invention. The steps described in the first embodiment with reference to FIG. 3 are denoted with the same reference numerals in FIG. 5, and the detailed description thereof is omitted.

In the third embodiment illustrated in FIG. 5, the processing of step S22 is executed instead of step S12 of the first embodiment.

The parameters stored in the NAND flash memory 30 include a parameter for setting a clock frequency of the system, which is used when the CPU 12 transfers the main program from the NAND flash memory 30 to the DRAM 20, and a parameter for setting a pulse width of a control signal, which is used when the CPU 12 accesses the NAND flash memory 30.

At step S22 for initializing the system, the CPU 12 performs setting of the clock frequency of the system and setting of the NAND memory controller 18 for the transfer of the program, in accordance with the parameter for setting the clock frequency and the parameter for setting the pulse width of the control signal, which parameters are included in the parameters stored in the SRAM 16. Thus, the main program can be transferred at any rate (high rate), and the booting time can be reduced.

### Fourth Embodiment

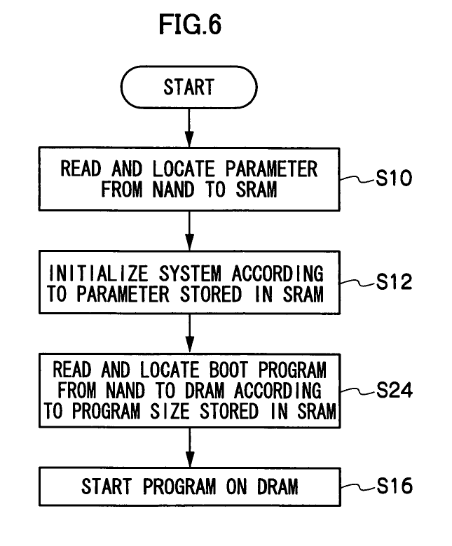

FIG. 6 is a flowchart illustrating operations for starting the electronic apparatus according to a fourth embodiment of the present invention. The steps described in the first embodiment with reference to FIG. 3 are denoted with the same reference numerals in FIG. 6, and the detailed description thereof is omitted.

In the fourth embodiment illustrated in FIG. 6, the processing of step S24 is executed instead of step S14 of the first embodiment.

The parameters stored in the NAND flash memory 30 include a parameter indicating a size of the main program.

At step S24, the CPU 12 reads the main program from the NAND flash memory 30 while using the parameter indicating the size of the main program, which parameter is one of the parameters stored in the SRAM 16, and locates the read main program in the DRAM 20. Thus, the electronic apparatus can be adapted to any of the main programs of various sizes without changing the ROM code.

### Fifth Embodiment

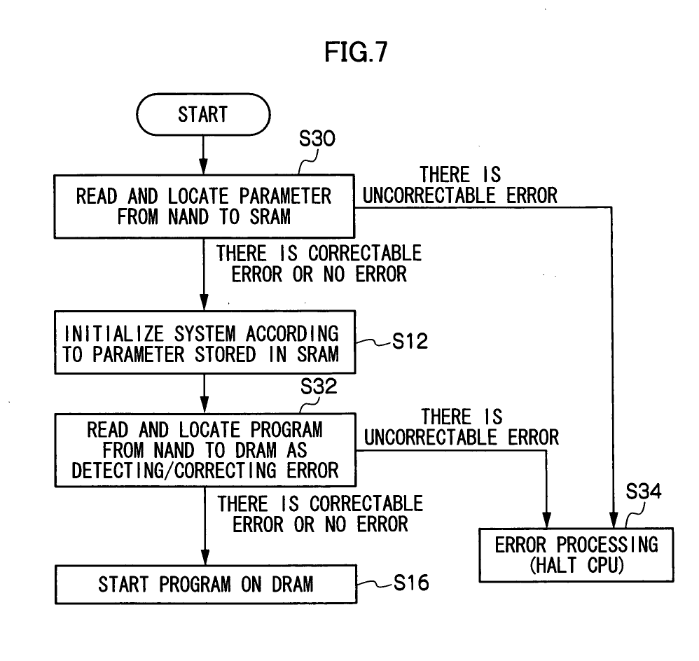

FIG. 7 is a flowchart illustrating operations for starting the electronic apparatus according to a fifth embodiment of the present invention. The steps described in the first embodiment with reference to FIG. 3 are denoted with the same reference numerals in FIG. 7, and the detailed description thereof is omitted.

In the fifth embodiment illustrated in FIG. 7, the processing of steps S30 and S32 is executed instead of steps S10 and S14 of the first embodiment, and the processing of step S34 is added.

The NAND memory controller 18 has the error detection and correction function of the reading. The parameters and the main program which are stored in the NAND flash memory 30 include error correction codes, respectively.

In FIG. 7, the NAND memory controller 18 reads the parameters along with the error correction code from the NAND flash memory 30, and performs the error detection and correction for the read parameters by using the error correction code. The parameters having been subjected to the error detection and correction are stored in the SRAM 16 (step S30).

When it is detected that an uncorrectable error has been induced in the parameters at step S30, the process moves to step S34, where an error processing (to halt the CPU 12) is executed.

After the CPU 12 performs the system initialization by using the parameters, the NAND memory controller 18 reads the main program along with the error correction code from the NAND flash memory 30, and performs the error detection and correction for the read main program by using the error correction code. The main program having been subjected to the error detection and correction is located in the DRAM 20 (step S32).

When it is detected that an uncorrectable error has been induced in the main program at step S32, the process moves to step S34, where the error processing (to halt the CPU 12) is executed.

Thus, it is possible to increase the reliability of the parameters and the main program stored in the NAND flash memory 30, of which reliability is lower than that of the NOR flash memory.

### Sixth Embodiment

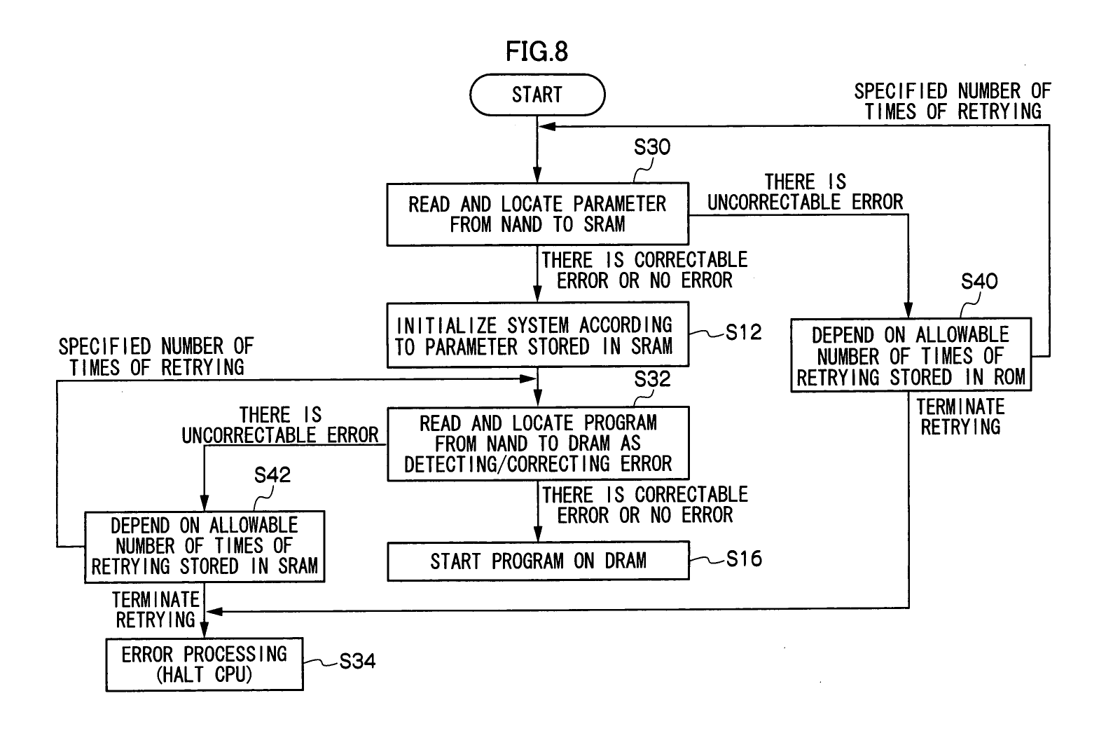

FIG. 8 is a flowchart illustrating operations for starting the electronic apparatus according to a sixth embodiment of the present invention. The steps described in the fifth embodiment with reference to FIG. 7 are denoted with the same reference numerals in FIG. 8, and the detailed description thereof is omitted.

In the sixth embodiment illustrated in FIG. 8, the processing of steps S40 and S42 is added to the fifth embodiment.

The ROM code includes a parameter indicating an allowable number of times of retrying when the parameters are transferred, and the parameters stored in the NAND flash memory 30 include a parameter indicating an allowable number of times of retrying when the main program is transferred.

When it is detected that an uncorrectable error has been induced in the parameters at step S30, the process moves to step S40, where it is determined whether or not the number of times of retrying has reached the allowable number of times designated with the parameter included in the ROM code. If the number of times of retrying has not yet reached the allowable number of times, the process goes back to step S30, and if the number of times of retrying has reached the allowable number of times, the process moves to step S34, where the error processing (to halt the CPU 12) is executed.

Similarly, when it is detected that an uncorrectable error has been induced in the main program at step S32, the process moves to step S42, where it is determined whether or not the number of times of retrying has reached the allowable number of times designated with the parameter stored in the SRAM 16. If the number of times of retrying has not yet reached the allowable number, the process goes back to step S32, and if the number of times of retrying has reached the allowable number of times, the process moves to step S34, where the error processing (to halt the CPU 12) is executed.

As described above, if it is detected that the uncorrectable error has been induced when the CPU 12 transfers the parameters or the main program, the CPU 12 retries the transfer of the parameters or the main program within the limit of the designated allowable number of times of retrying. Thus, the reliability when transferring the parameters and the main program can be increased.

### Another Configuration the Electronic Apparatus

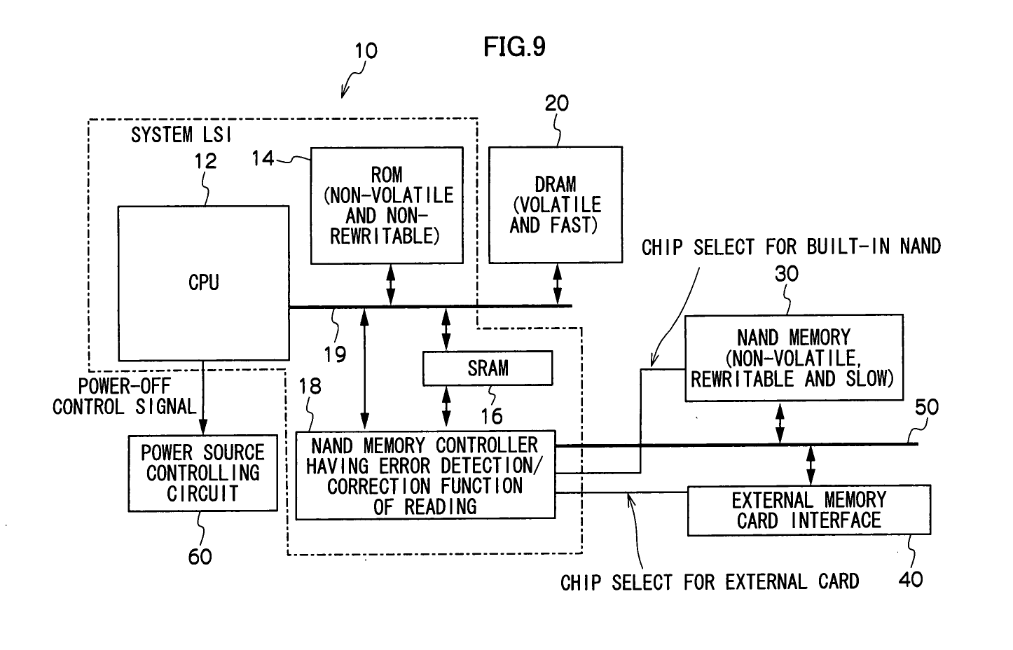

FIG. 9 is a main block diagram illustrating an electronic apparatus according to another embodiment of the present invention. The members described with reference to FIG. 1 are denoted with the same reference numerals in FIG. 9, and the detailed description thereof is omitted.

In FIG. 9, the ROM code stored in the ROM 14 includes a code that the CPU 12 executes, when the transferred parameters or the transferred main program has an error that is not correctable with the error correction code nor the retrying of the transfer, to issue a power-off control signal to a power source controlling circuit 60 so as to turn off the power to the CPU 12 itself or the whole system from the CPU 12, as an error processing.

The parameters read from the NAND flash memory 30 includes a parameter indicating whether or not the CPU 12 should perform the issuance of the power-off control signal as the error processing.

### Seventh Embodiment

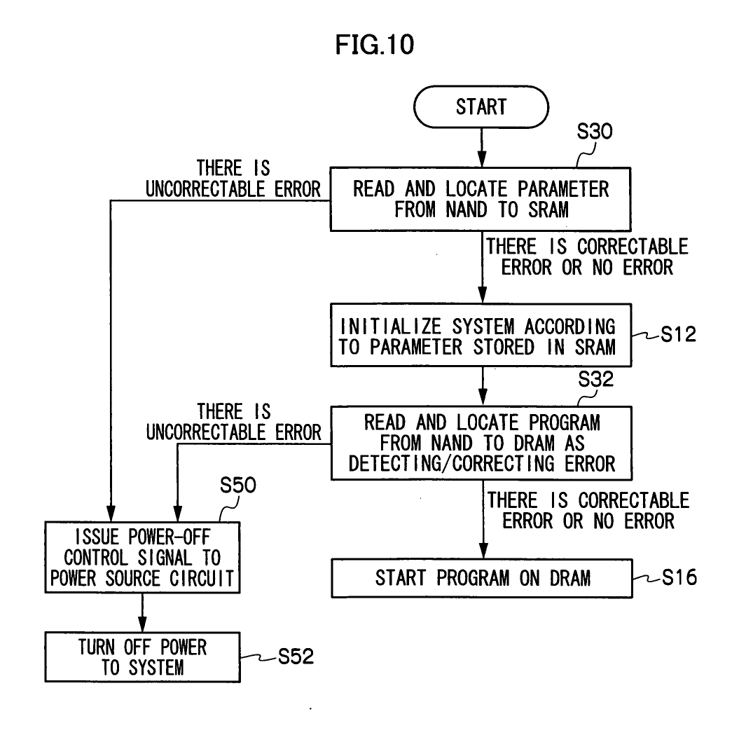

FIG. 10 is a flowchart illustrating operations for starting the electronic apparatus according to a seventh embodiment of the present invention. The steps described in the fifth embodiment with reference to FIG. 7 are denoted with the same reference numerals in FIG. 10, and the detailed description thereof is omitted.

In the seventh embodiment illustrated in FIG. 10, the processing of steps S50 and S52 is executed instead of the error processing (step S34) of the fifth embodiment.

When the parameter indicating that the CPU 12 should perform the issuance of the power-off control signal as the error processing is set in the parameters read from the NAND flash memory 30, if it is detected that an uncorrectable error has been induced when the CPU 12 transfers the parameters or the main program, the CPU 12 issues the power-off control signal to the power source controlling circuit 60 (step S50).

When the power source controlling circuit 60 receives the power-off control signal, the power source controlling circuit 60 turns off the power to the CPU 12 or the whole system (step S52). Thus, the system is protected when the system is not normally started.

### Another Configuration of the NAND Flash Memory 30

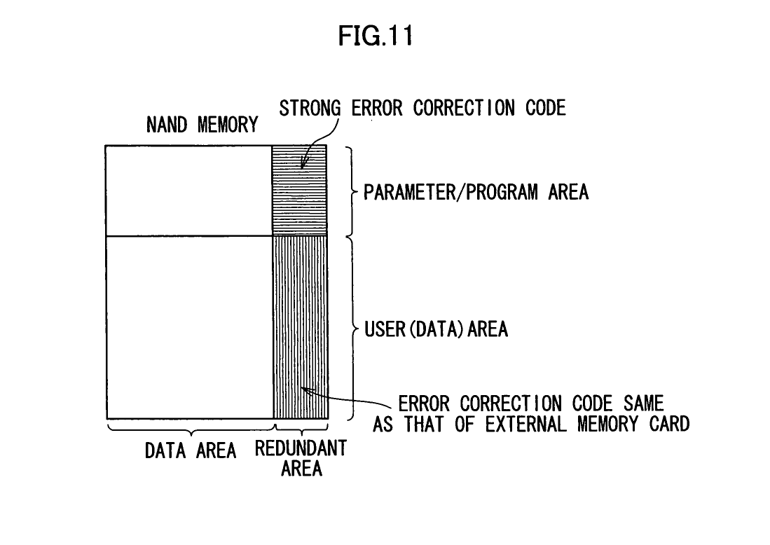

FIG. 11 is a diagram illustrating a memory map of the NAND flash memory 30 in which data areas and redundant areas are defined. As illustrated in FIG. 11, the NAND flash memory 30 is divided to a parameter/main program area, in which the parameters and the main program are stored, and a user area, which a user can utilize.

The parameter/main program area includes the data area, in which the parameters and the main program are stored, and the redundant area, in which a first error correction code to be used to detect and correct errors in the transferred parameters and the transferred main program is stored. The user area includes the data area, in which the user data is stored, and the redundant area, in which a second error correction code to be used to detect and correct errors in the user data is stored. The first error code in the parameter/main program area is capable of error correction stronger than the second error correction code, which is the same error correction code as that of the memory card.

Here, it is possible that a Reed-Solomon code is used as the first error correction code in the parameter/main program area, and matrix Hamming codes are used as the second error correction code in the user area.

Although it is more preferable to effectively utilize the memory capacity that the redundant area is smaller, the parameters and the main program are provided with the strong error correction code, since the parameters and the main program are important for the system.

Meanwhile, the present invention can be applied to a digital camera which uses an external recording medium such as a memory card, and an electronic apparatus such as a digital audio player and an IC recorder.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An electronic apparatus, comprising:
a central processing unit;
a non-volatile memory which is non-rewritable and stores a boot program;
a first volatile memory which enables fast reading and writing of data and does not require initialization;
a second volatile memory which enables fast reading and writing of data and requires initialization; and
a first flash memory which is serial and stores at least a parameter necessary for the central processing unit to perform initialization of a system in an area designated with a first physical address, and a main program to be executed by the central processing unit in an area designated with one of a second physical address and the parameter,
wherein when the electronic apparatus is powered on, the central processing unit executes the boot program stored in the non-volatile memory so that the central processing unit performs transfer of the parameter from the first flash memory to the first volatile memory by reading the parameter from the first flash memory and temporarily storing the read parameter into the first volatile memory, and then performs the initialization of the system according to the parameter stored in the first volatile memory, thereafter performs transfer of the main program stored in the first flash memory to the second volatile memory, and then starts the main program on the second volatile memory.

2. The electronic apparatus as defined in claim 1, further comprising:
a memory controller which includes an error detection and correction device, wherein:
the central processing unit performs the transfer of the parameter and the main program through the memory controller; and
the memory controller performs error detection and correction for the parameter and the main program transferred through the memory controller.

3. The electronic apparatus as defined in claim 2, wherein the central processing unit, the non-volatile memory, the first volatile memory, and the memory controller are configured in one chip of large-scale integrated circuit.

4. The electronic apparatus as defined in claim 1, further comprising:
an interface which externally connects with a second flash memory and transmits and receives data with the second flash memory, the second flash memory being serial,
wherein the first volatile memory which temporarily stores the parameter at the initialization serves as a data buffer when the second flash memory is used.

5. The electronic apparatus as defined in claim 1, wherein the parameter stored in the first flash memory includes a parameter for initializing the second volatile memory.

6. The electronic apparatus as defined in claim 1, wherein the parameter stored in the first flash memory includes:
a parameter for setting a clock frequency of the system by which the central processing unit performs the transfer of the main program from the first flash memory to the second volatile memory, and
a parameter for setting a pulse width of a control signal by which the central processing unit accesses the first flash memory.

7. The electronic apparatus as defined in claim 1, wherein the parameter stored in the first flash memory includes a parameter indicating a size of the main program to be transferred from the first flash memory to the second volatile memory.

8. The electronic apparatus as defined in claim 2, wherein:
the parameter stored in the first flash memory includes a parameter indicating an allowable number of times of retrying when the central processing unit performs the transfer of the main program; and
if it is detected that an uncorrectable error has been induced when the central processing unit performs the transfer of the main program, the central processing unit retries the transfer of the main program within a limit of the allowable number of times of retrying.

9. The electronic apparatus as defined in claim 2, wherein:
the boot program stored in the non-volatile memory includes a parameter indicating an allowable number of times of retrying when the central processing unit performs the transfer of the parameter and the main program; and
if it is detected that an uncorrectable error has been induced when the central processing unit performs the transfer of one of the parameter and the main program, the central processing unit retries the transfer of the one of the parameter and the main program within a limit of the allowable number of times of retrying.

10. The electronic apparatus as defined in claim 2, wherein if it is detected that an uncorrectable error has been induced when the central processing unit performs the transfer of the parameter and the main program, the central processing unit issues a control signal so as to turn off power of a power source circuit.

11. The electronic apparatus according to claim 2, wherein:
the first flash memory has a user area in which user data is stored;
the first flash memory stores a first error correction code in an area in which the parameter and the main program are stored; and
the first flash memory stores a second error correction code in the user area, the second error correction code being capable of error correction weaker than the first error correction code.
